(19) United States
(12) Patent Application Publication
(10) Pub. No.: US 2009/0235659 A1
(43) Pub. Date: Sep. 24, 2009

(54) Energy Source Device

(76) Inventor: Yung-Chuan LIN, Jhonghe City (TW)

Correspondence Address: Troxell Law Office Pllc, Suite 1404, 5205 Leesburg Pike, Falls Church, VA, 22041, US

(21) Appl. No.: 12/134,321

(22) Filed: Jun. 6, 2008

(30) Foreign Application Priority Data
Mar. 24, 2008 (TW) 097110444

(51) Int. Cl. F03B 17/02

(52) U.S. Cl. 60/495

(57) ABSTRACT

The present invention relates to an energy source device, which includes a potential energy change device, an energy acquiring device and an object transfer device. The potential energy change device is prefilled with material having density greater than air to enable more than one object having a density smaller than the density of the material to gain potential energy from the density difference between the material and the objects. Furthermore, the objects are moved to the energy acquiring device using the object transfer device, and weight of each of the objects themselves and the principle of kinetic and potential energy transformation are used to acquire a predetermined potential energy difference, which is transformed into energy. Accordingly, basic principles of physics are used to acquire needed energy from the predictable energy produced by buoyancy and gravitational acceleration, thereby achieving environmental protection and meeting the objective of providing economic benefit.

### BACKGROUND OF THE INVENTION

(a) Field of the Invention

The present invention provides an energy source device, and more particularly provides an energy source device that is able to use predictable energy produced by buoyancy and gravitational acceleration to acquire needed energy, thereby achieving environmental protection and meeting the objective of providing economic benefit.

(b) Description of the Prior Art

Petroleum is the primary energy source of all industries and the livelihood of people, moreover, petroleum has brought a great deal of convenience to people, as well as enabling the continuous progress and improvement in technology and the quality of life, such as industrial development, lifestyle, and so on. However, at another level, petroleum has at the dame time brought about many problems and extremely serious conditions, including air pollution, ecological disasters, greenhouse effect, climatic change, and so on. Currently, the extraction and use of large quantities of petroleum, purported to be a “black gold” product, by people has caused the storage volume of petroleum to be substantially less than in the past. Hence, the ever increasing price of petroleum, which has contributed to creating a global energy crisis, rapid price inflation, economic recession, and associated influences. In light of this, many determined people have carried out research and developed numerous energy source substitute devices able to replace petroleum as an energy source, such as: solar cells, wind power generators, nuclear energy power generators, hydroelectric power generators, and so on, in which the method which makes use of nature to acquire energy is the most appropriate to meet modern environmental protection requirements.

However, manufacturing cost of the aforementioned energy substitute devices is not only extremely expensive; moreover, benefit of the actual energy obtained is not in direct proportion to the manufacturing cost. Taking wind power generation as an example, manufacturing cost of a single typhoon wind turbine can be easily more than ten million Taiwan dollars, nevertheless, the energy produced is usually unable to prove its worth. When a typhoon arrives, there is concern that the wind turbine will be damaged by the powerful strong winds, and, thus, operation of the wind turbine is stopped and rigorously protected. Hence, under such conditions, the wind turbine is not only unable to produce energy, but also completely wastes the original value of the wind turbine. As for nuclear energy power generation, energy is obtained through nuclear means, however, because nuclear power is classified as a highly radioactive substance, thus, inappropriate control easily results in ecological disasters occurring, and the loss is instead far greater than the gain. Furthermore the used nuclear waste must be carefully buried, which not only requires protective measures of the surrounding area, but requires an extensive hinterland in order to place the nuclear waste Hence, although the energy obtained by nuclear means is quick and effective, however, it completely violates the laws of nature, and seriously affects global ecology.

### SUMMARY OF THE INVENTION

Hence, in light of the aforementioned shortcomings, the inventor of the present invention has designed an energy source device of the present invention which is able to use predictable energy produced by buoyancy and gravitational acceleration to acquire needed energy, thereby achieving environmental protection and meeting the objective of providing economic benefit.

A primary objective of the present invention lies in an energy source device, which comprises a potential energy change device, an energy acquiring device and an object transfer device, wherein the potential energy change device is prefilled with material having density greater than air, thereby enabling more than one object having a density smaller than the density of the material to gain potential energy from the density difference between the material and the objects. Moreover, a bottom portion of the potential energy change device is installed with a flow guide pipe that enables the surplus material and air to be discharged to within the potential energy change device, and a one-way valve that prevents reverse flow of water and air is disposed at a preset position in the flow guide pipe. Furthermore, the objects are moved to the energy acquiring device by means of the object transfer device, and weight of each of the objects themselves and the principle of kinetic and potential energy transformation are used to acquire a predetermined potential energy difference, which is transformed into energy and supplied to an external device for use thereof, after which the objects are transferred to the potential energy change device from the energy acquiring device by means of the object transfer device. Accordingly, basic principles of physics are used to acquire needed energy from the predictable energy produced by buoyancy and gravitational acceleration, thereby achieving environmental protection and meeting the objective of providing economic benefit.

Another objective of the present invention lies in: according to what has been described above, cost of assembling the energy device is extremely low, and the available energy obtained is not only directly proportional but goes beyond manufacturing cost.

Yet another objective of the present invention lies in: because the energy source device cycles infinitely for use thereof operation of which does not need to be stopped due to external environmental factors, thus, it enables the user to obtain a continuous supply of energy without having to worry about the problem of the energy source being interrupted.

To enable a further understanding of said objectives and the technological methods of the invention herein, a brief description of the drawings is provided below followed by a detailed description of the preferred embodiments.

### BRIEF DESCRIPTION OF THE DRAWINGS

FIG. 1 shows a first operational flow process diagram depicting a preferred embodiment of the present invention.

FIG. 2 shows a second operational flow process diagram depicting the preferred embodiment of the present invention.

FIG. 3 shows a third operational flow process diagram depicting the preferred embodiment of the present invention.

FIG. 4 shows a first partial operational flow process diagram depicting the preferred embodiment of the present invention.

FIG. 5 shows a second partial operational flow process diagram depicting the preferred embodiment of the present invention.

FIG. 6 shows a third partial operational flow process diagram depicting the preferred embodiment of the present invention.

FIG. 7 shows a first partial operational flow process diagram depicting another preferred embodiment of the present invention.

FIG. 8 shows a second partial operational flow process diagram depicting the other preferred embodiment of the present invention.

FIG. 9 shows a third partial operational flow process diagram depicting the other preferred embodiment of the present invention.

FIG. 10 shows a fourth partial operational flow process diagram depicting the other preferred embodiment of the present invention.

FIG. 11 shows a first partial operational flow process diagram depicting yet another preferred embodiment of the present invention.

FIG. 12 shows a second partial operational flow process diagram depicting the yet other preferred embodiment of the present invention.

FIG. 13 shows a third partial operational flow process diagram depicting the yet other preferred embodiment of the present invention.

### DETAILED DESCRIPTION OF THE PREFERRED EMBODIMENTS

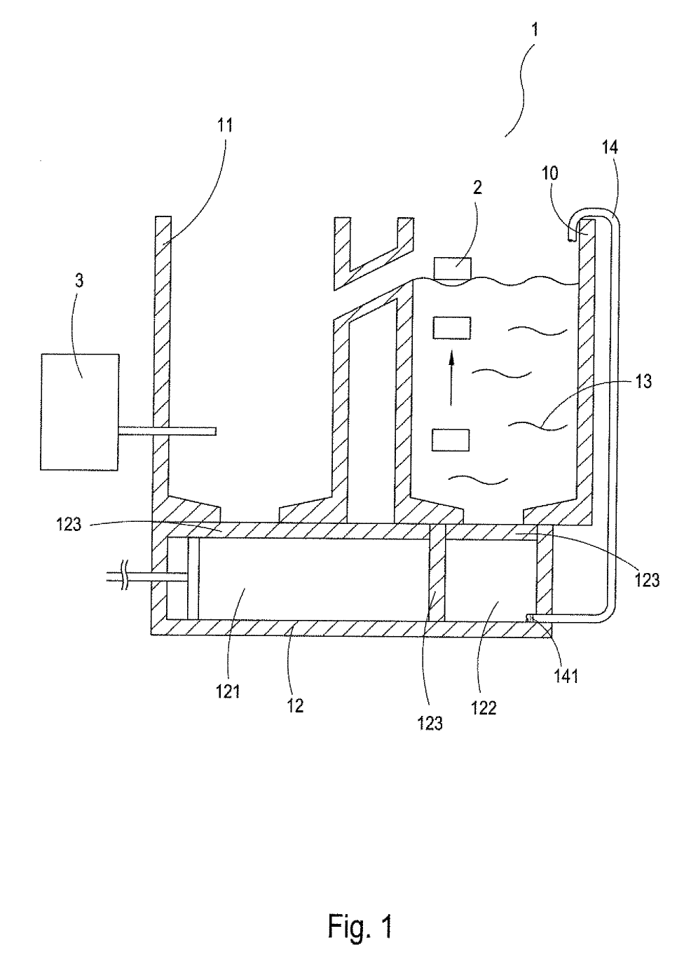

Referring to FIG. 1, which shows a preferred embodiment of a first operational flow process diagram of the present invention, and it can be clearly seen from the drawing that an energy source device 1 comprises a potential energy change device 10, an energy acquiring device 11 and an object transfer device 12, wherein the potential energy change device 10 is prefilled with material 13 having density greater than air, thereby enabling more than one object 2 having a density smaller than the density of the material 13 to gain potential energy from the density difference between the material 13 and the objects 2. Moreover, a bottom portion of the potential energy change device 10 is installed with a flow guide pipe 14 that enables the surplus material 13 and air to be discharged to within the potential energy change device 10, and a one-way valve 141 that prevents reverse flow of water and air is disposed at a preset position in the flow guide pipe 14. Furthermore, the objects 2 are moved to the energy acquiring device 11 by means of the object transfer device 12, and weight of each of the objects 2 themselves and the principle of kinetic and potential energy transformation are used to acquire a predetermined potential energy difference, which is transformed into energy and supplied to an external device 3 for use thereof, after which the objects 2 are transferred to the potential energy change device 10 from the energy acquiring device 11 by means of the object transfer device 12. In addition, the object transfer device 12 comprises at least more than two sets of a first retaining area 121 and a second retaining area 122, which are respectively installed with a plurality of lock gates 123 at preset positions.

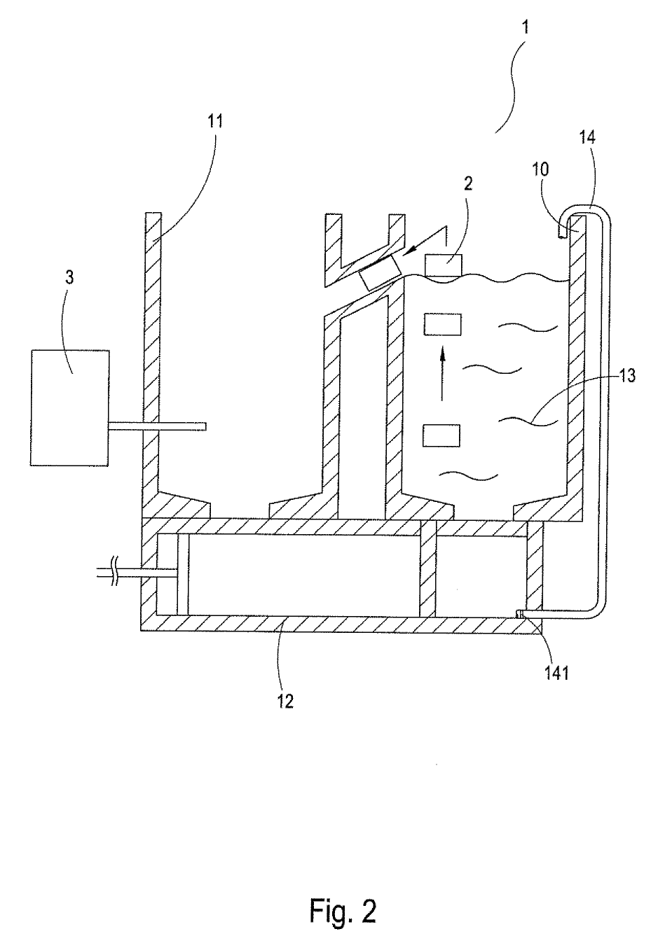

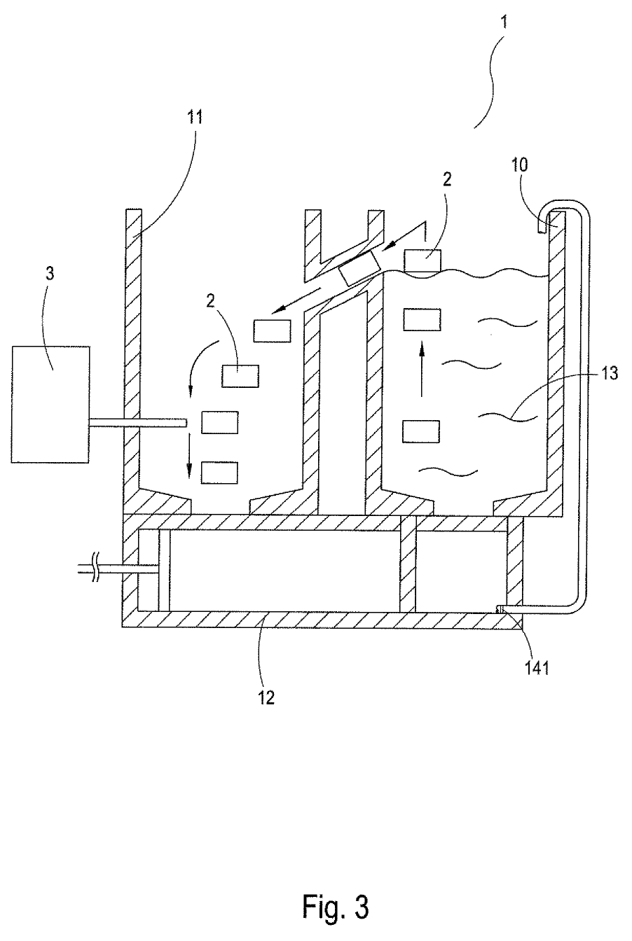

Referring together to FIG. 2 and FIG. 3, which show second and third operational flow process diagrams respectively of the preferred embodiment according to the present invention, and it can be clearly seen from drawings that the buoyant force of liquid within the potential energy change device 10 causes the potential energy of the objects 2 (such as: wood blocks, iron blocks, aluminum blocks, copper blocks) therein to change, and when the objects 2 are transferred to the energy acquiring device 11 by means of the object transfer device 12, then the objects 2 are caused to fall toward a preset position of the energy acquiring device 11 through gravitational acceleration means, after which, when the objects 2 have fallen to a predetermined height, the external device 3 acquires needed energy therefrom. Accordingly, using basic principles of physics, the predictable energy produced through buoyancy and kinetic and potential energy transformation enables acquiring needed energy, thereby achieving environmental protection and meeting the objective of providing economic benefit.

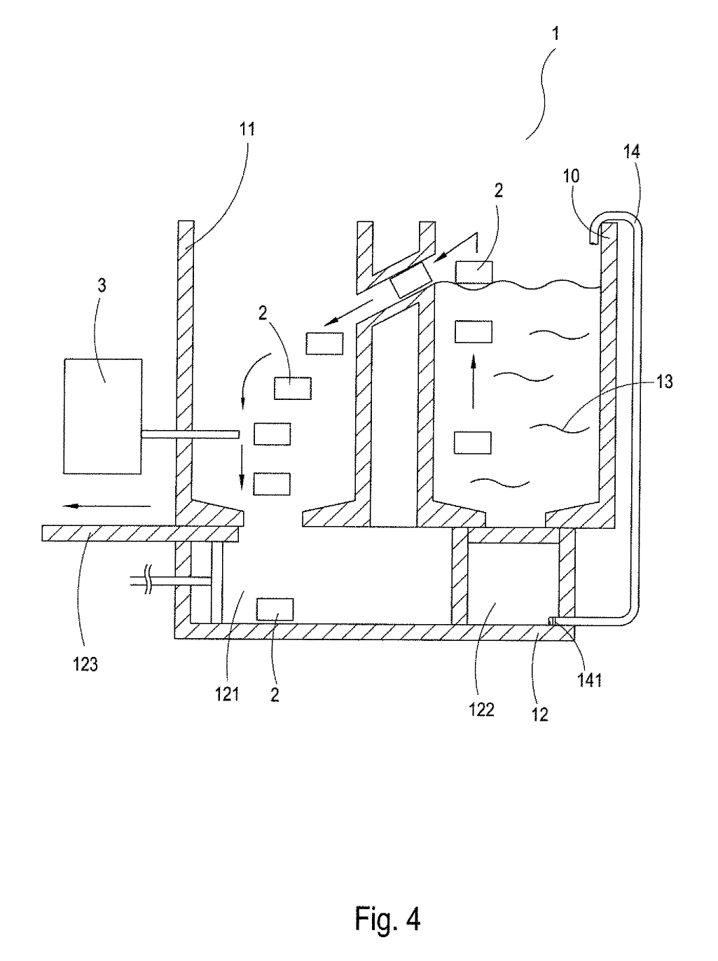

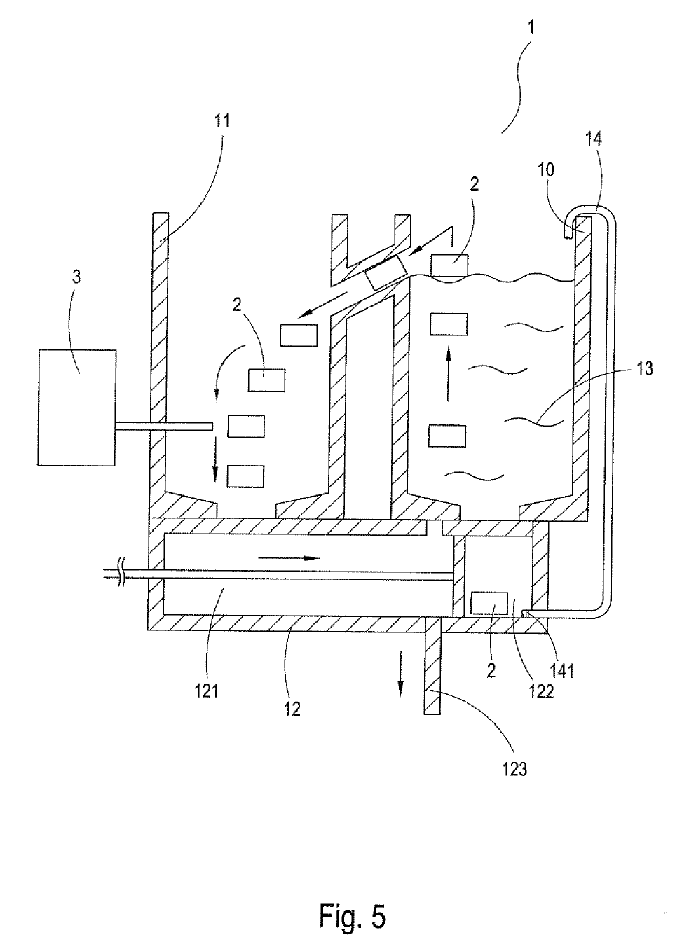

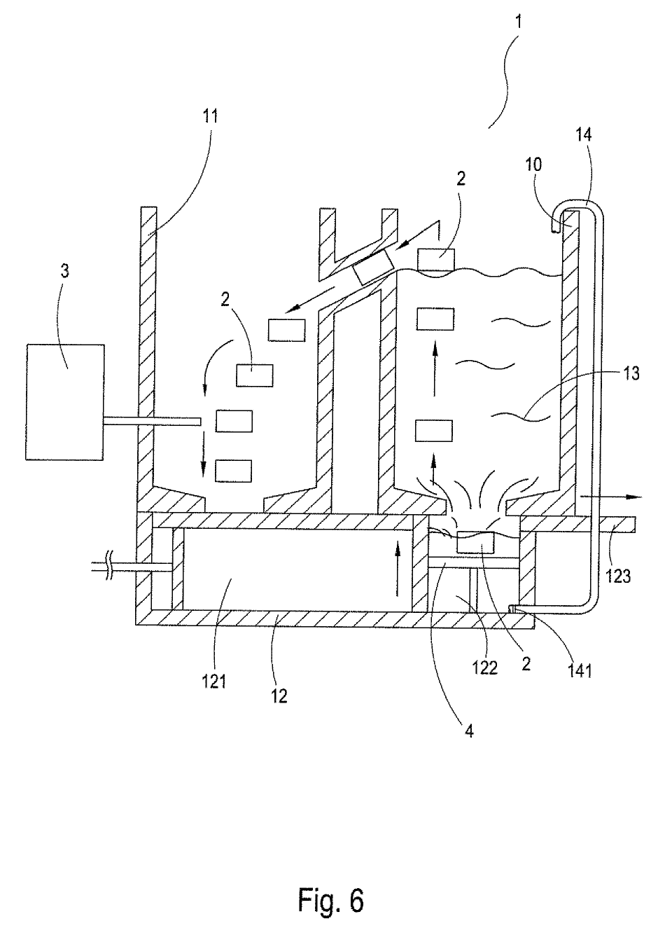

Furthermore, referring to FIG. 4, FIG. 5 and FIG. 6, which show first, second and third partial operational flow process diagrams respectively of the preferred embodiment according to the present invention, and it can be clearly seen from the drawings that the object transfer device 12 comprises at least more than two sets of the first retaining area 121 and the second retaining area 122, which are respectively installed with the plurality of lock gates 123 at preset positions, and when the objects 2 fall and approach the object transfer device 12, then the lock gate 123 of the first retaining area 121 of the object transfer device 12 adjacent to the energy acquiring device 11 opens, thereby enabling the objects 2 to fall into the first retaining area 121, after which the lock gate 123 between the first retaining area 121 and the second retaining area 122 opens, at which time the object transfer device 12 assumes a closed state. After the objects 2 are subjected to an external force and moved towards and positioned within the second retaining area 122, then the lock gate 123 between the first retaining area 121 and the second retaining area 122 closes, at which time, the second retaining area 122 assumes a closed state, and at the same time the lock gate 123 of the second retaining area 122 adjacent to the potential energy change device 10 opens Because a mechanical pusher device 4 having a load bearing range equal to the space of the second retaining area 122 is located at a preset position in the second retaining area 122, thus, when the liquid within the potential energy change device 10 flows into the second retaining area 122, then the mechanical pusher device 4 simultaneously pushes the objects 2 and the liquid toward the interior of the potential energy change device 10, after which the lock gate 123 adjacent to the potential energy change device 10 is closed, thereby causing the second retaining area 122 to assume a closed state. At which time, the flow guide pipe 14 is able to discharge the surplus material 13 within the second retaining area 122 and air to within the potential energy change device 10, thereby enabling smooth operation of the mechanical pusher device 4 without being affected by air pressure, and, furthermore, the one-way valve 141 disposed at a preset position in the flow guide pipe 14 enables preventing back flow of liquid and air into the second retaining area 122. Accordingly, the device enables a continuous cycling operation of the objects 2, and uses physical properties to achieve acquiring energy, as well as meeting the objective of providing substantive benefit to environmental protection.

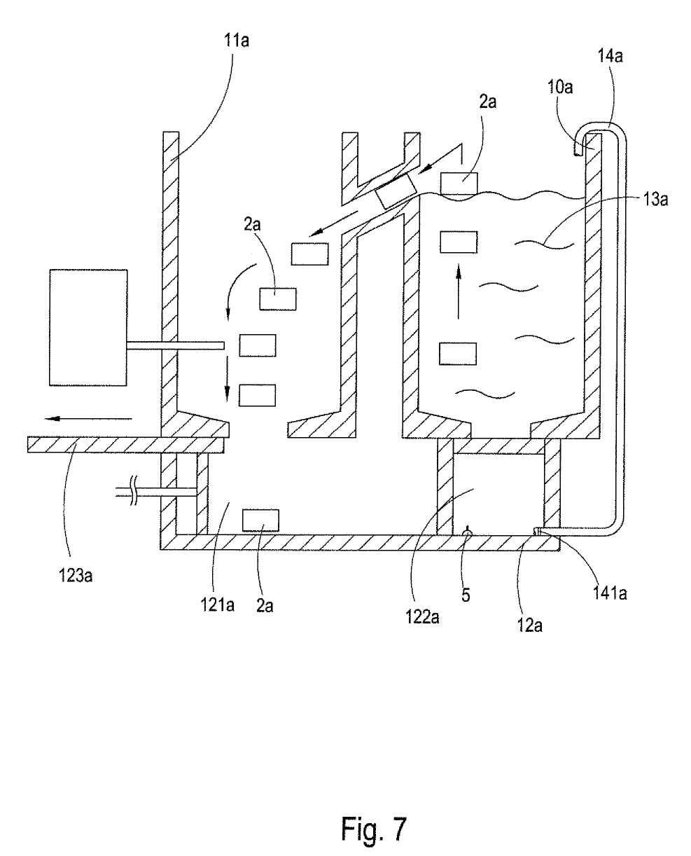

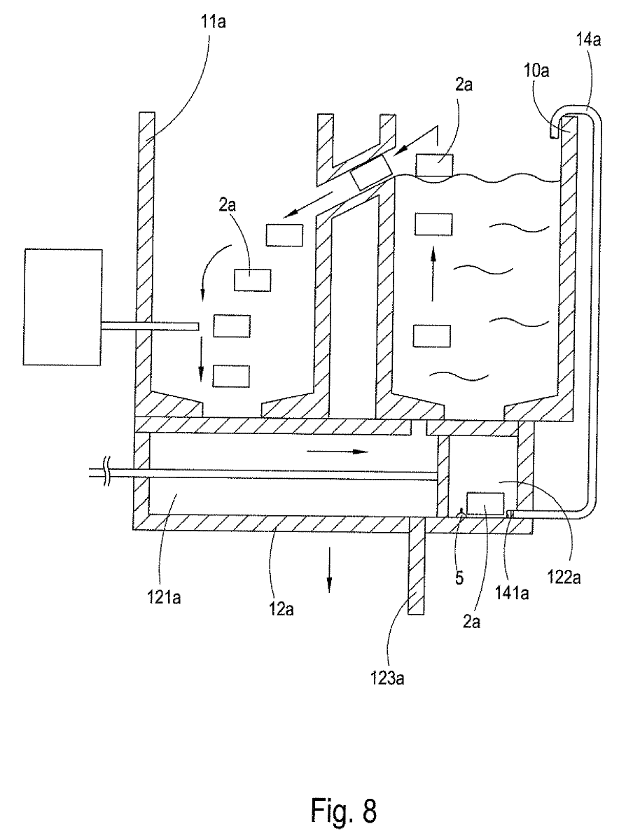

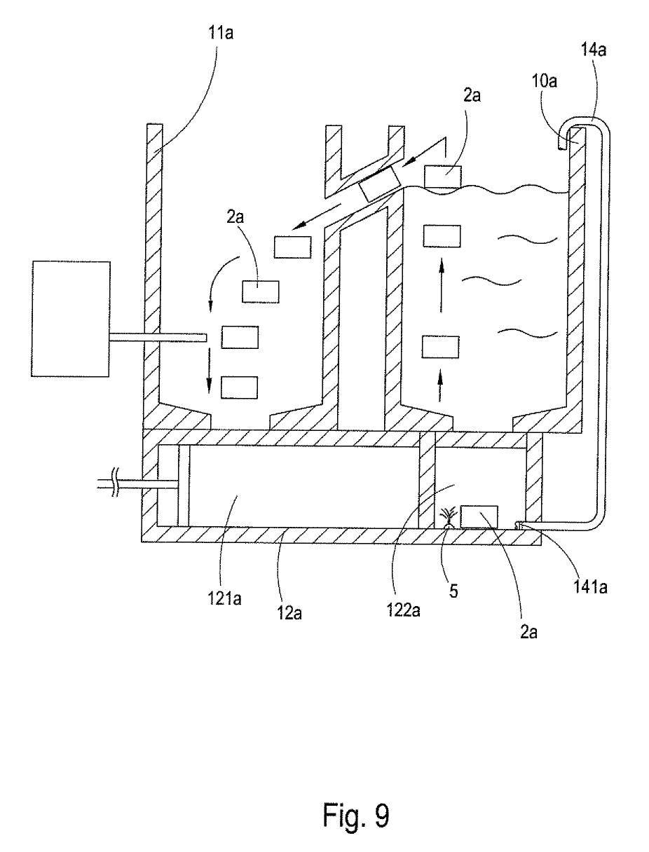

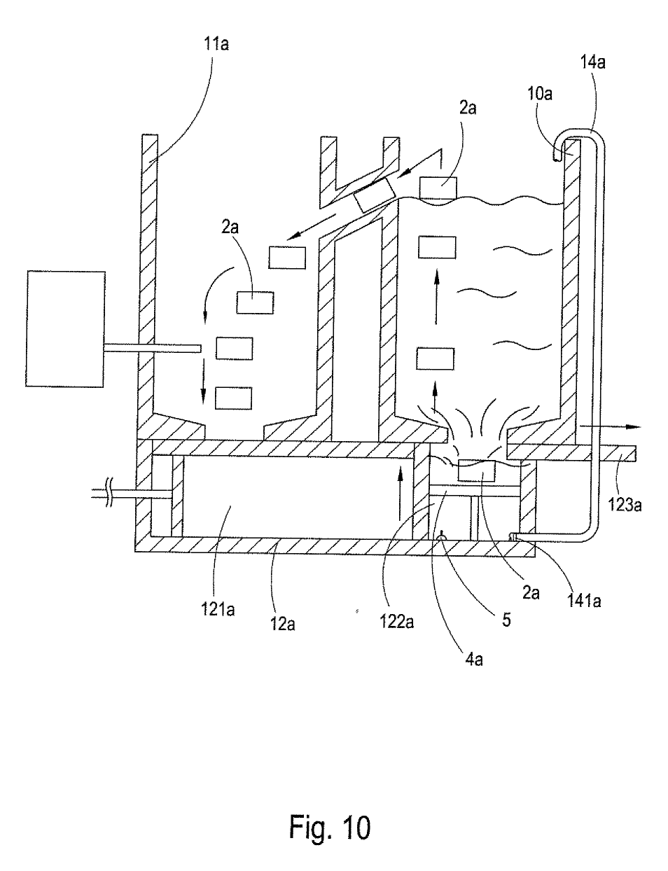

Referring to FIG. 7, FIG. 8, FIG. 9 and FIG. 10, which show first, second, third and fourth partial operational flow process diagrams respectively of another preferred embodiment according to the present invention, and in conjunction with FIG. 1, FIG. 2 and FIG. 3, it can be clearly seen from the drawings that an object transfer device 12a comprises at least more than two sets of a first retaining area 121a and a second retaining area 122a, which are respectively installed with a plurality of lock gates 123a at preset positions, and when objects 2a fall and approach the object transfer device 12a, then the lock gate 123a of the first retaining area 121a of the object transfer device 12a adjacent to an energy acquiring device 11 a opens, thereby enabling the objects 2a to fall into the first retaining area 121a, after which the lock gate 123a between the first retaining area 121a and the second retaining area 122a opens, at which time the object transfer device 12a assumes a closed state. After the objects 2a are subjected to an external force and moved towards and positioned within the second retaining area 122a, then the lock gate 123a between the first retaining area 121a and the second retaining area 122a closes, at which time the second retaining area 122a assumes a closed state. Because an air charging device 5 able to eject gas having a density lower than that of the liquid is installed at a preset position in the second retaining area 122a, thus, when the objects 2a are moved into the second retaining area 122a, then the second retaining area 122a begins to be filled with gas, and after the second retaining area 122a has been filled with a predetermined volume of gas, then the lock gate 123a adjacent to the potential energy change device 10a opens. Accordingly, when the liquid within the potential energy change device 10a flows into the second retaining area 122a, then a mechanical pusher device 4a simultaneously pushes the objects 2a and the liquid into the potential energy change device 10a, after which the lock gate 123a adjacent to the potential energy change device 10a is closed, thereby causing the second retaining area 122a to assume a closed state. At which time, a flow guide pipe 14a is able to discharge surplus material 13a within the second retaining area 122a and air to within the potential energy change device 10a, thereby enabling smooth operation of the mechanical pusher device 4a without being affected by air pressure, and, furthermore, a one-way valve 141a disposed at a preset position in the flow guide pipe 14a enables preventing back flow of liquid and air into the second retaining area 122a. Accordingly, the device enables the objects 2a to be pushed towards the interior of the potential energy change device 10a by gaseous means, thus causing a continuous cycling operation of the objects 2a, and further uses physical properties to achieve acquiring energy, as well as meeting the objective of providing substantive benefit to environmental protection.

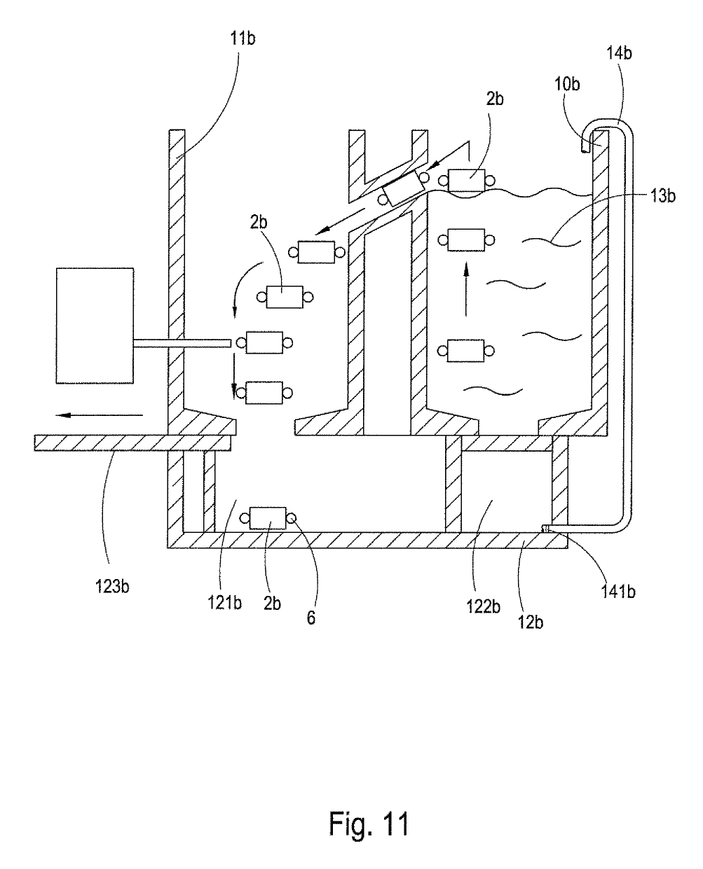

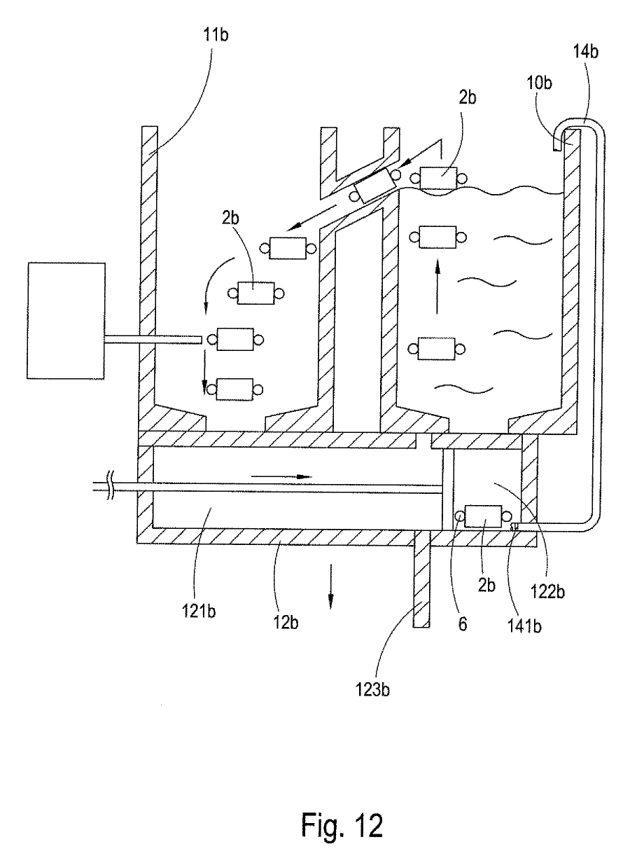

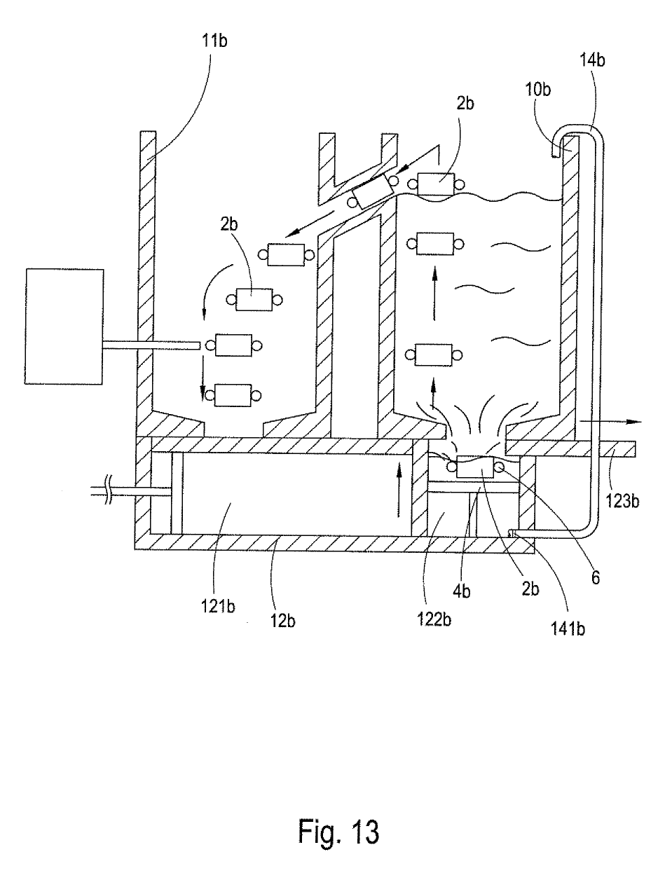

Referring to FIG. 11, FIG. 12 and FIG. 13, which show first, second and third partial operational flow process diagrams respectively of yet another preferred embodiment according to the present invention, and in conjunction with FIG. 1, FIG. 2 and FIG. 3, it can be clearly seen from the drawings that more than one float device 6 having a density lower than that of the density of the liquid is fitted at preset positions of the periphery of each object 2b, and that an object transfer device 12b comprises at least more than two sets of a first retaining area 121b and a second retaining area 122b, which are respectively installed with a plurality of lock gates 123b at preset positions, and when the objects 2b fall and approach an object transfer device 12b, then the lock gate 123b of the first retaining area 121b of the object transfer device 12b adjacent to an energy acquiring device 11b opens, thereby enabling the objects 2b to fall into the first retaining area 121b, after which the lock gate 123b between the first retaining area 121b and the second retaining area 122b opens, at which time the object transfer device 12b assumes a closed state. After the objects 2b are subjected to an external force and moved towards and positioned within the second retaining area 122b, then the lock gate 123b between the first retaining area 121b and the second retaining area 122b closes, at which time the second retaining area 122b assumes a closed state, and at the same time the lock gate 123b of the second retaining area 122b adjacent to a potential energy change device 10b opens. Because a mechanical pusher device 4b having a load bearing range equal to the space of the second retaining area 122b is installed at a preset position in the second retaining area 122b, thus, when the liquid within the potential energy change device 10b flows into the second retaining area 122b, then the mechanical pusher device 4b simultaneously pushes the objects 2b and the liquid toward the interior of the potential energy change device 10b, after which the lock gate 123b adjacent to the potential energy change device 10b is closed, thereby causing the second retaining area 122b to assume a closed state. Accordingly, when the objects 2b are moved to the second retaining area 122b, then the lock gate 123b of the second retaining area 122b adjacent to the potential energy change device 10b opens, whereupon the liquid within the potential energy change device 10b flows into the second retaining area 122b, and the mechanical pusher device 4b simultaneously pushes the objects 2b, having more than one of the float devices 6 with density lower than that of the density of the liquid fitted at preset positions of the periphery thereof, and the liquid into the potential energy change device 10b, after which the lock gate 123b adjacent to the potential energy change device 10b is closed, thereby enabling the second retaining area 122b to assume a closed state, at which time, a flow guide pipe 14b is used to discharge surplus material 13b within the second retaining area 122b and air to within the potential energy change device 10b, thereby enabling smooth operation of the mechanical pusher device 4b without being affected by air pressure, and, furthermore, a one-way valve 141b disposed at a preset position in the flow guide pipe 14b enables preventing back flow of liquid and air into the second retaining area 122b. Accordingly, the float devices 6 fitted to the periphery of each of the objects 2b are used to push the objects 2b toward the interior of the potential energy change device 10b and effect a continuous cycling operation, and further uses physical properties to achieve acquiring energy, as well as meeting the objective of providing substantive benefit to environmental protection.

Hence, the key factors that enable the energy source device 1 of the present invention to improve on the prior art are described as follows:

1. Basic principles of physics are used to acquire needed energy from the predictable energy produced by buoyancy and gravitational acceleration, thereby achieving environmental protection and meeting the objective of providing economic benefit.

2. Cost of assembling the energy source device 1 is extremely low, and the available energy obtained is not only directly proportional but goes beyond manufacturing cost.

3. Because the energy source device 1 cycles infinitely to producing energy for use thereof, operation of which does not need to be stopped due to external environmental factors, thus, it enables the user to obtain a continuous supply of energy without having to worry about the problem of the energy source being interrupted.

It is of course to be understood that the embodiments described herein are merely illustrative of the principles of the invention and that a wide variety of modifications thereto may be effected by persons skilled in the art without departing from the spirit and scope of the invention as set forth in the following claims.

What is claimed is:

1. An energy source device, comprising:
a potential energy change device, the potential energy change device being prefilled with material having density greater than air to enable more than one object having a density smaller than the density of the material to gain potential energy from the density difference between the material and the objects;
an energy acquiring device, the energy acquiring device using weight of each of the objects themselves and the principle of kinetic and potential energy transformation to acquire a predetermined potential energy difference; and
an object transfer device, the object transfer device enabling objects to be transferred to the potential energy change device from the energy acquiring device.

2. The energy source device according to claim 1, wherein the potential energy change device causes the objects to be displaced to the energy acquiring device from a preset position using potential energy difference gained from density difference.

3. The energy source device according to claim 2, wherein the object transfer device is connected to a preset position of the energy acquiring device.

4. The energy source device according to claim 2, wherein the object transfer device comprises at least more than two sets of a first retaining area and a second retaining area, and the retaining areas are respectively installed with a plurality of lock gates at preset positions.

5. The energy source device according to claim 4, wherein the second retaining area is installed with a mechanical pusher device able to push the objects toward the interior of the potential energy change device.

6. The energy source device according to claim 4, wherein the second retaining area is installed with an air charging device able to eject gas having a density lower than that of the liquid.

7. The energy source device according to claim 1, wherein more than one float device having a density lower than that of the density of the liquid is fitted at preset positions of the periphery of each object.

8. The energy source device according to claim 1, wherein the energy acquiring device supplies energy to an external device for use thereof the energy being transformed from a predetermined potential energy difference acquired from the free falling of the objects.

9. The energy source device according to claim 1, wherein a bottom portion of the potential energy change device is installed with a flow guide pipe that enables surplus material and air to be discharged to within the potential energy change device.

10. The energy source device according to claim 9, wherein a one-way valve that prevents reverse flow of water and air is disposed at a preset position in the flow guide pipe.
